(19) United States
(12) Patent Application Publication
(10) Pub. No.: US 2026/0320539 A1
(43) Pub. Date: Oct. 15, 2026

(54) UPDATING MASTER TRANSPORTATION DATA

(71) Applicant: Certu Systems, Inc., Pittsburgh, PA (US)

(72) Inventors: Hyong Sok Kim, Pittsburgh, PA (US); Oguzhan Karaahmetoglu, Pittsburgh, PA (US)

(21) Appl. No.: 19/179,796

(22) Filed: Apr. 15, 2025

(51) Int. Cl. G06Q 10/0833

(52) U.S. Cl. CPC G06Q 10/0833

(57) ABSTRACT

One embodiment provides a method, the method including: tracking, utilizing a master data exception system, transportation of at least one object during execution of a shipment plan, wherein the shipment plan is generated using master data and includes at least one transportation order for the at least one object; identifying, based upon the tracking, an exception during the execution of the shipment plan, wherein the exception identifies a change with respect to the shipment plan that occurred during execution of the shipment plan; and automatically updating, based upon receipt of a predetermined number of exceptions corresponding to the same master data, the master data corresponding to the exception. Other aspects are claimed and described.

### BACKGROUND

Logistics is the process of managing how objects are obtained, stored, and transported to a final destination of the object. The transportation of objects includes transportation from a manufacturing facility to a destination where objects might be utilized by different companies or entities. The transportation also includes storing objects within warehouses until a final location is identified. The warehouses provide a buffer for the storage of objects that can fulfill a demand while new quantities of the object are manufactured. Thus, an entity may be able to order an object and receive it within a short period of time as opposed to having to wait until the object is manufactured. To get objects from one location to another, for example, from a manufacturing location to a warehouse, from a warehouse to another warehouse, from a warehouse to a final location, and/or the like, different transportation modes may be utilized. Different transportation modes may include boats, airplanes, trucks, and/or the like. These transportation modes allow for the transportation of many different goods at the same time, which is particularly useful for the movement of large amounts of objects from one location to another.

### BRIEF SUMMARY

In summary, one aspect provides a method, the method including: tracking, utilizing a master data exception system, transportation of at least one object during execution of a shipment plan, wherein the shipment plan is generated using master data and includes at least one transportation order for the at least one object; identifying, based upon the tracking, an exception during the execution of the shipment plan, wherein the exception identifies a change with respect to the shipment plan that occurred during execution of the shipment plan; and automatically updating, based upon receipt of a predetermined number of exceptions corresponding to the same master data, the master data corresponding to the exception.

Another aspect provides a system, the system including: a processor; a memory device that stores instructions that, when executed by the processor, causes the system to: track, utilizing a master data exception system, transportation of at least one object during execution of a shipment plan, wherein the shipment plan is generated using master data and includes at least one transportation order for the at least one object; identify, based upon the tracking, an exception during the execution of the shipment plan, wherein the exception identifies a change with respect to the shipment plan that occurred during execution of the shipment plan; and automatically update, based upon receipt of a predetermined number of exceptions corresponding to the same master data, the master data corresponding to the exception.

A further aspect provides a product, the product including: a computer-readable storage device that stores executable code that, when executed by a processor, causes the product to: track, utilizing a master data exception system, transportation of at least one object during execution of a shipment plan, wherein the shipment plan is generated using master data and includes at least one transportation order for the at least one object; identify, based upon the tracking, an exception during the execution of the shipment plan, wherein the exception identifies a change with respect to the shipment plan that occurred during execution of the shipment plan; and automatically update, based upon receipt of a predetermined number of exceptions corresponding to the same master data, the master data corresponding to the exception.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example device.

FIG. 2 illustrates an example method for automatically updating master data used to generate shipment plans for the transportation of objects by identifying exceptions that occur during the execution of a shipment plan.

### DETAILED DESCRIPTION

In a product lifecycle, the product or object is generally moved from one location to another. Some of these locations include the manufacturing facility and warehouses or product storage locations that store the products or objects until they are needed or desired. When the product or object needs to be moved, a transportation order is created to move the object from the current location to the target location. Frequently, a logistics company will take care of creating a shipment plan. The logistics company will receive the transportation order which identifies what object is to be moved, an amount of the object to be moved, and a destination of the object. The transportation order may include additional information including, but not limited to, a preferred origin location, a preferred transporter, and/or the like.

Some or all of this information may be stored within a data repository referred to as master data. This master data may be utilized by the logistic company, or other entity that is creating the shipment plan, to create the shipment plan. The shipment plan details all the relevant information that will be needed to move the object from an origin location to a destination location. The relevant information may include everything from the type of transportation vehicle to the route that should be taken to transport the object. The relevant information may also identify how long the transportation will take, any inventory constraints, any transportation constraints, and/or the like. The shipment plan may include a single transportation order or may include multiple transportation orders for multiple objects that may be included on the same route, on the same transportation vehicle, the same objects being delivered to multiple locations or picked up from multiple locations, and/or the like.

Once the shipment plan is generated, it is transmitted to the company that will actually effectuate the transportation of the object. This company or entity may be the one that dispatches transportation vehicles, the company or entity that is holding the objects for transport, and/or the like. During the execution of the shipment plan, events may occur that cause the shipment plan to not be followed exactly. These events are referred to as exceptions, which causes changes to the execution of or with respect to the shipment plan. Exceptions can be anything related to origin locations, transporters, transportation vehicles, destination locations, transportation routes, and/or the like. For example, if a load is not delivered when the shipment plan said it should have been delivered, this is an exception with respect to or in view of the shipment plan. Other example exceptions may include, but are not limited to, a change in the acceptable transportation vehicle that can be received by the receiver, route restrictions for transportation vehicles, parking time limitations for transportation vehicles, loading and offloading time length based upon loader or receiver operations, and/or the like. Some exceptions are single occurrences and some exceptions occur more often. In some cases, the exceptions should result in the master data being updated.

Traditionally, to identify exceptions with respect to shipment plans, a user identifies the exception. The user may or may not remember the exceptions to identify a pattern or root cause of the exceptions. In other words, in traditional systems a person has to keep track of the exceptions to determine if there is a root cause that is resulting in the exception. Identification of the root cause may result in determining that the master data should be changed in order to prevent future exceptions. For example, if the reason that the load was not delivered per the shipment plan is because the unloading hours of the destination has changed, the master data reflecting the unloading hours should be modified. This change has to be made manually by a user. Thus, there are many deficiencies to this system that result in inefficiencies to the transportation system, for example, delays to shipments, inaccurate information relied upon for shipment plans, and/or the like.

Accordingly, the described system and method provides a technique for automatically updating master data used to generate shipment plans for the transportation of objects by identifying exceptions that occur during the execution of a shipment plan. The master data exception system tracks the transportation of at least one object during execution of a shipment plan. The shipment plan is generated using master data accessible by the master data exception system and includes a transportation order for the object. The transportation order identifies origin location for the object, details regarding the transportation of the object, and the destination location for the object. From this shipment plan, a transporter and provided details on when and how an object will get from one location to another location. The shipment plan is intended to be as optimized as possible and, if followed, should result in the most efficient transportation of the object.

However, the shipment plan relies on the master data and if the master data is incorrect, then inefficiencies are introduced into the shipment plan. Thus, the system is able to identify when exceptions occur during execution of the shipment plan. An exception identifies a change with respect to the shipment plan that occurred during the execution of the shipment plan. For example, if the objects were to be delivered at a certain time, if the objects were not delivered at that time, then an exception has occurred to the shipment plan. The system may identify the cause of the exception and then track these exceptions. Upon receiving a predetermined number of exceptions that correspond to the same master data, the system can automatically update the master data that is related to the exception. In other words, if the system determines a pattern or identifies that the same exception keeps occurring, the master data can be updated. The predetermined number of exceptions may vary based upon the master data that is being updated. Thus, the predetermined number may be as few as a single occurrence, or could be many more occurrences or a particular frequency of occurrence.

Therefore, a system provides a technical improvement over traditional methods for the transportation of objects. The described master data exception system provides a technical improvement to the transportation technological field. Millions of tons of freight are transported in the United States each day. Inefficiencies in the transportation field cause delays, causes orders to take longer to transport, and causes many headaches for companies who want freight transported, companies who are trying to receive freight, and companies who are tasked with transporting the freight. The transportation of objects is becoming more and more reliant on computing systems to create shipment orders and determine the best plan for transporting objects in order to reduce these inefficiencies. These computing systems are deficient for the transportation of objects for multiple reasons. One issue is caused due to the fact that the computing system relies on a database in order to create shipment plans. The database includes the information that would be necessary to generate a shipment plan. However, most of the subsequent steps rely on human operators.

One of these steps is identifying when a shipment plan does not go to plan and determining what went wrong to cause the shipment plan to not be executed per the plan. The described system is able to identify these exceptions and also automatically update the master data based upon determining whether the exception is a unique one-time occurrence, or whether the exception is something that needs to be changed. Since this master data is kept within a data repository that includes very large amounts of information, making updates manually is inefficient, can often be inaccurate, and can take a long time to make the change which results in additional shipment plans being generated based upon incorrect information. Since the information has been stored in the computing system data repository, the issue has necessarily become a computer problem that requires a computing solution, which is what is provided by the described system. The use of the computing system to identify and make the updates based upon exceptions results in a much faster transportation computing system that is able to access accurate data to make shipment plans, thereby significantly improving the transportation technological field by reducing some of the inefficiencies in the process and allowing for an improved transport of the millions of tons of freight in the United States each day.

The illustrated example embodiments will be best understood by reference to the figures. The following description is intended only by way of example, and simply illustrates certain example embodiments.

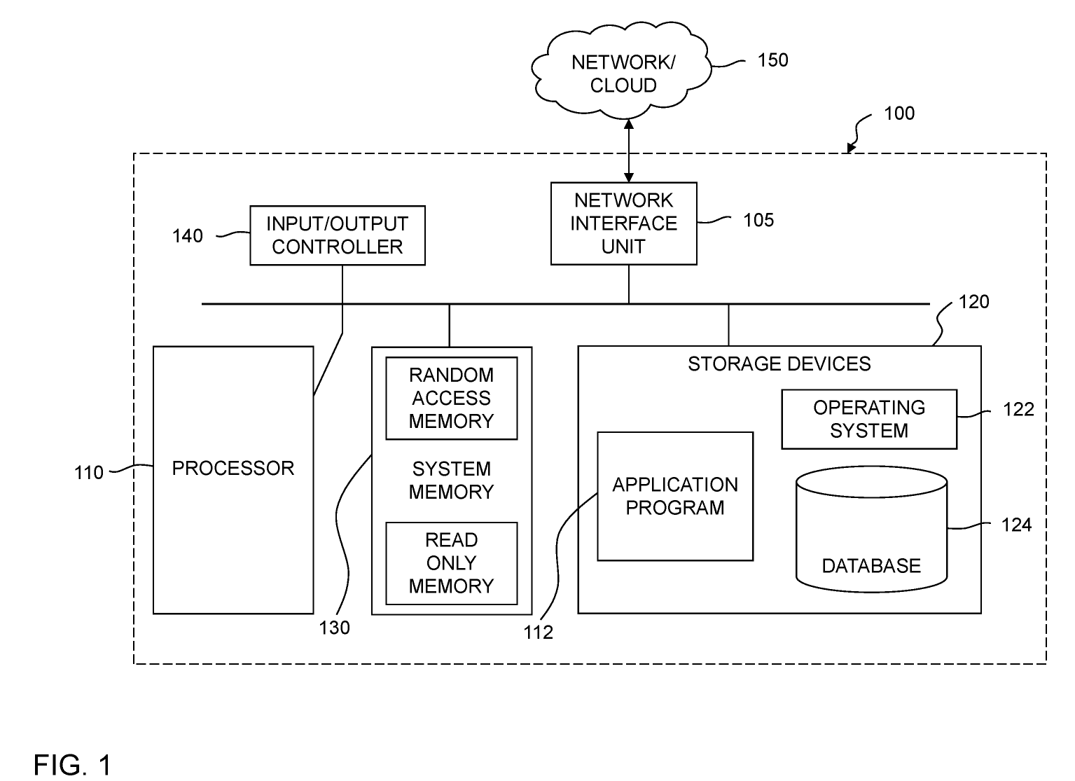

While various other circuits, circuitry or components may be utilized in the described system, an example is illustrated in FIG. 1. In the example of FIG. 1, storage devices 120 includes software such as a workflow graphical user interface application program 112 that may be run or executed by processor(s) 110 according to an operating system 122. The circuitry 100 provides that the processor 110 loads the operating system 122 and thereafter the application program 112, e.g., into memory 130.

System 100 typically includes a network interface 105 facilitating communications with other devices, e.g., a connection to other devices over a network 150 (which may include a local network, remote network, cloud network, etc.) using components such as a WWAN transceiver, a WLAN transceiver or a wired connection, e.g., a LAN connection. Commonly, system 100 will include an input/output controller 140 for data input and display. System 100 typically includes various memory 130 and storage devices 120, for example a database 124, e.g., for storing data from internal and external data sources, referred to herein.

Device circuitry, as for example outlined in FIG. 1, may be used to generate, manage, and process data collected during the operation of the program. It will also be apparent that circuitry other than the non-limiting example outlined in FIG. 1 may be used. Information handling device circuitry, as for example outlined in FIG. 1, may be used in devices such as tablets, smart phones, personal computer devices generally, electronic devices, and/or the like, that may interface with the shipment ordering system, be a part of the shipment ordering system, and/or utilized by users, including transporters, to access information provided within or by the shipment ordering system.

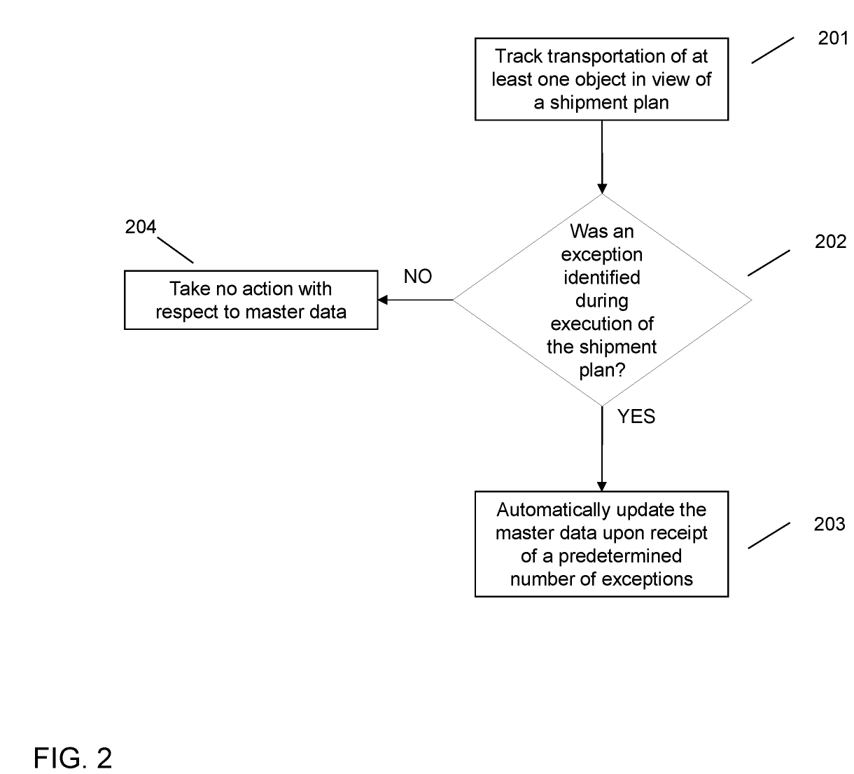

FIG. 2 illustrates an example method for receiving and validating modifications to a shipment plan for an object and tracking the object during the transportation. The method may be implemented on a system which includes a processor, memory device, output devices (e.g., display device, etc.), input devices (e.g., keyboard, touch screen, mouse, microphones, sensors, biometric scanners, etc.), image capture devices, and/or other components. While the system may include known hardware and software components and/or hardware and software components developed in the future, the system itself is specifically programmed to perform the functions as described herein to update master data that is utilized to create shipment plans. Additionally, the master data exception system includes modules and features that are unique to the described system.

The master data exception system may be utilized to automatically update master data that is utilized to create shipment plans. In order to utilize the master data exception system, the system may be activated, either as a standalone application, as a module that works with another application, and/or the like, or a combination thereof. The system may be automatically activated by an application that provides instructions to the system or may be manually activated by a user providing input to the system. The automatic activation of the master data exception system may be based upon the detection of a trigger event indicating that the system should be activated. Example trigger events include identification that an object is to be transported, identification of an exception that occurred during execution of a shipment plan, activation of software or an application utilizing the shipment ordering system, and/or the like.

The master data exception system may be made of multiple systems or modules that communicate together to make up the master data exception system or may be a single system. The master data exception system may be a system within an organization, for example, a logistics organization, a supplier, and/or any other organization that may arrange transport of objects. The master data exception system may communicate with other systems within the organization and may also communicate with other systems outside the organization, for example, systems of other entities that may transmit transportation requests (e.g., organizations that want transportation objects transported, etc.), inventory control organizations, transportation request generation organizations, systems or devices corresponding to users or people that are involved in the transportation of objects (e.g., transporter devices, transportation vehicle devices, shipper devices, receiver devices, etc.), and/or the like. Thus, the master data exception system may include components or modules that allow for the communication between the master data exception system and the internal and/or external systems. These components or modules may be all located on a single computing device or single computing system, or different components or modules of the system could be located across multiple computing devices or multiple computing system.

The master data exception system may be a standalone system, may be accessible through other computing devices, and/or a combination thereof. For example, the master data exception system may be a standalone system that can be accessed by a user and/or may be or provide an application that is accessible by a user on another computing device. The master data exception system may be accessible using any type of computing device, for example, personal computer, laptop computer, smartphone, tablet, smartwatch, head-mounted display, smart television or other smart appliance, augmented reality device, virtual reality device, and/or the like.

Thus, the master data exception system may be accessible locally using a computing device where the master data exception system is installed and/or may be accessible remotely through another computing device. For example, the master data exception system may be accessed by a user using a device that communicates with the master data exception system to identify exceptions with respect to a shipment plan, update master data based upon identified exceptions, and/or the like. However, the master data exception system may be located and operate on a different information handling device to perform the described steps. For example, the master data exception system may be located and operate on a cloud computing device, a computing device accessed through a remote network, a computing device accessed through a local network, and/or the like, or a combination thereof.

The master data exception system may have an associated graphical user interface. The graphical user interface may be provided on a display or monitor, which may or may not be associated with the shipment ordering system. In other words, the master data exception system may have a dedicated display or monitor or may be accessible using any display or monitor. In either case, the master data exception system may provide instructions to generate and display the graphical user interface on the display device being used to access the shipment ordering system. The graphical user interface may also be updated and managed based upon instructions provided by the shipment ordering system. In other words, the master data exception system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the master data exception system. For example, the master data exception system may utilize historical information, transporter information, origin location information, destination location information, inventory information, and/or the like, to track transportation of an object during execution of a shipment plan, identify an exception with respect to a shipment plan, update master data based upon identified exceptions, and/or the like. The graphical user interface may allow for creation of or access to these profiles, historical information, and/or the like, by allowing a user to input information regarding the shipment plans, inventory constraints, transportation constraints, and/or the like. As will be discussed in more detail, the use of user provided information is not the only way that the historical information, transporter information, inventory information, and/or the like, can be created. The shipment organization system can then utilize these inputs to store the historical information, identify exceptions, update master data, and/or the like.

A user could also use the graphical user interface to adjust information stored within the system, make changes to generated shipment plans, access information utilized to generate the shipment plan, identify an exception and reason for an exception, and/or the like. Additionally, or alternatively, the user can input a location of information related to the information, provide a file corresponding to the information or portion thereof, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display different information that is utilized by the system, output by the system, generated by the system, and/or the like. It should be noted that the information to be used by the master data exception system and information provided by the master data exception system can be different for different applications, different computing systems, different users, and/or the like. Thus, the information corresponding to input or output of the master data exception system are not always the same. However, the master data exception system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The master data exception system may utilize one or more artificial intelligence models in identifying exceptions, updating master data based upon exceptions, and/or any other steps included in the system or method. Artificial intelligence models may also be used for steps within a step. For example, a model could be utilized to track a number or frequency of exceptions that are related to the same master data in order to determine that the master data should be updated, analyze sensor data in tracking the transportation of the object to identify an exception, and/or the like.

For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the master data exception system or may be a model that is created from scratch. Since the master data exception system is used in conjunction with identifying exceptions and updating master data based upon identified exceptions, some models that may be utilized by the system are text analysis models, image analysis models, sensor information analysis models, other analysis models, optimization models, similarity identification models, large language models, language models, filtering models, classification models, mapping models, and/or the like. The model may be trained using one or more training datasets.

Additionally, as the model is deployed, it may receive feedback to become more accurate over time. Alternatively, or additionally, the model may utilize inputs provided to the model to learn continually, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model. Alternatively, or additionally, the user can provide additional content that should be used to be further train, retrain, or refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, active learning, transfer learning, weak supervision, data augmentation, weakly supervised learning, and/or the like. Accordingly, the training dataset may include annotated data, unannotated data, and/or the like, or a combination thereof.

Whether the model automatically ingests feedback during deployment or not may be determined by a user, author, and/or entity that has deployed the model. Automatic learning by the model may be useful in some applications, but may be detrimental in other applications. Accordingly, a user may make a determination regarding the trainability of the model during deployment. Regardless of whether the model can be retrained during deployment or is only retrained upon instruction by a user, the feedback or inputs could be stored within a data store and utilized at a later time to train or retrain the model. For example, a user could use the feedback to update a training dataset to train or retrain the model.

The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

The AI model may also include a guardrail. The guardrail is a protocol and tool that ensures the AI model operate as intended by the AI model author or owner. The guardrail ensures that the model operates within defined boundaries and principals. The guardrail may be utilized to perform an initial determination regarding whether the AI model is allowed or authorized to respond to a query, allowed or authorized to make a determination, and/or the like. In other words, the guardrail acts as a gatekeeper to the full processing of the AI model. If the guardrail rejects a query or determination request, then the AI model will not be employed to respond or make the determination. On the other hand, if the guardrail approves a query or determination request, then the query or determination request is provided to the AI model for processing. As an example, a query or determination request may be rejected if the information is not valid, if an unauthorized user is making the query or request, if the AI model is unable to respond to such queries or requests, and/or the like.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model. Additionally, the feature sets, vectors, layers, outputs, and/or other characteristics of the model may be chosen by a user based upon the application.

The master data exception system may include different components for carrying out different functions of the system, including different steps to be performed. These components may be hardware components or software components. Some hardware devices or components that may be utilized by the master data exception system include input devices that may be utilized to receive input from the user, for example, mechanical input modalities (e.g., keyboard, mouse, etc.), touch input devices, gesture input devices, electromyography input devices, audio input devices, biometric input devices, and/or the like. Other hardware components may be utilized to provide output from the shipment ordering system. For example, the master data exception system may include speakers, displays or monitors, haptic output devices, audio output devices, and/or the like.

Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the master data exception system, and/or the like. The master data exception system may also interface with hardware components of a device. For example, instead of the master data exception system including a display, the master data exception system may provide instructions to display content on a display component of a user device that is employing or communicating with the master data exception system.

One software component may include a data storage location or data repository that stores information related to content of an individual, user profiles, historical information, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by user, grouped by content type (e.g., spoken content, written content, image content, video content, etc.), and/or the like. The information stored within the data repository may be indexed or grouped based upon multiple identifiers or other characteristics. Thus, the data repository can allow for filtering and sorting.

Another software component includes a master data repository. The master data repository can include any conceivable information that is related to the transportation field. Such information may be related to inventory constraints, transportation constraints, destination constraints, and/or the like. The information within the master data repository includes information that is utilized to generate shipment plans. Thus, the information can be any information that is related to the transportation of objects and that can be used when generating a shipment plan. A shipment plan may identify objects to be transported, origin locations for the objects, destination locations for the objects, transporters for operating transportation vehicles, transportation vehicles for transporting the objects, and/or the like. Some of this information may be stored in or pulled from one or more profiles accessible by the master data exception system.

Inventory constraints may identify locations where inventory of the transportation objects is located (e.g., a warehouse, a manufacturing facility, etc.), identify how much of the transportation object is located at each location, identify when a transportation object will expire (if applicable), identify when a transportation object was placed at a particular location, identify how frequently the transportation object is replenished at a location, identifiers for transportation objects (e.g., product names, stock keeping unit (SKU) identifiers, barcodes, sizes of products, volumes of products, how products fit on a pallet, how products fit in a case, etc.), and/or the like. Thus, the inventory constraints may identify any information related to the objects themselves and locations of the objects.

Transportation constraints may identify information related to a transporter or transportation vehicle for a schedule of the transporter, regulations applicable to a transporter (e.g., a maximum number of working hours for a predetermined time frame, a required number of rest hours, route restrictions, etc.), whether the transporter works on a team, preferences of the transporter (e.g., preferred origin or delivery locations or regions, preferred load types (e.g., van loads, flatbed loads, tarped loads, less-than-a-load loads, multiple stop loads, etc.), preferred delivery routes, preferred delivery durations, etc.) transportation vehicle specifications, current routes of a transporter, current locations of a transporter, transportation vehicle identifiers, transporter identifiers, and/or the like. Thus, the transportation constraints may identify any information related to the transporter and transportation vehicle.

Destination and/or origin locations constraints may identify a preferred delivery schedule, preferred transporters, destination locations, a preferred frequency of delivery, any restrictions (e.g., restrictions regarding other objects that can be co-located on transportation vehicle with the object, regulations applicable to particular objects, how quickly objects need to be delivered, etc.), hours of operation, hours that goods or transportation objects can be picked up or delivered (e.g., only during business hours, only after hours, a subset of business hours, a range of hours, certain days, etc.), types and sizes of trucks or transportation vehicles that can access the origin/destination location, equipment available for use at the origin/destination location (e.g., forklift, hand carts, loading dock types, pallets, cranes, etc.) and a schedule of the equipment availability, employees that can release transportation objects and a schedule of these employees, preferences of the origin/destination location (e.g., preferred transporters, preferred pick up schedules, preferred frequency of order pick up, etc.), inventory delivery schedules, and/or the like. Thus, the Destination and/or origin locations constraints may identify any information related to the origin locations and destination locations.

It should be noted that while most data within the master data may be static and does not change frequently, some data may change. For example, inventory constraint information may change as inventory changes. As another example, schedules of transporters may vary and may, therefore, change. Thus, the data in the master data may change in real-time. However, traditionally, these changes are dictated by inputs to the system and are not based upon executions of shipment plans. The described system does provide a mechanism for updating the master data based upon the execution of shipment plans. Additionally, it should be noted that the types of information that are stored within the system or accessible to the system is not strictly limited to the types of information that have been discussed as it can be readily understood that other information may be useful and utilized. Thus, the described information is only for illustrative purposes and is not intended to be limiting to only that information described.

At 201, the master data exception system may track the transportation of at least one object during execution of a shipment plan. In other words, the system tracks the transportation of the object that is at least one subject of the shipment plan from the origin location to the destination location and therebetween. The shipment plan is generated using the master data and includes at least one transportation order for the at least one object. It should be noted that a single transportation object will be discussed herein for ease of readability. However, the shipment plan may include may transportation objects, multiple different types of transportation objects, objects being transported to different locations, objects being transported from different locations, on a route having multiple stops, and/or the like. A transportation object can be any type of product or object that can be transported from one location to another utilizing a transportation vehicle. Thus, transportation objects may include, but are not limited to, furniture, people, petroleum products, gas products, liquid products, food objects, office products, paper products, clothing, household objects, electronics, medical objects, and/or the like. Additionally, for ease of readability, a transportation object may also be referred to as an object or product. However, these terms are not intended to limit the transportation object in any way.

A transportation order may be based upon a transportation request that is received by the master data exception system or a system in operative communication with the master data exception system, for example, another system of a logistics organization. The transportation request may be transmitted by another system, for example, another system internal to the organization employing the shipment ordering system, another system that is external to the organization employing the shipment ordering system, and/or the like. For example, a company may want to have transportation objects transported to a destination location. This company may then transmit a transportation request to a logistics organization that coordinates the transportation of the transportation object.

The transportation request may identify a transportation object, an amount of the transportation object that needs to be transported, and a destination location for the transportation object. The transportation request may also identify to where the transportation object is to be delivered, which is referred to as the destination location. It should be noted that it is possible to have multiple destination locations for either portions of the same transportation object or for different objects that are on the same transportation vehicle. Multiple destinations for the same transportation vehicles are generally referred to as multi-stop routes. Loads that take up less than the entirety of a transportation vehicle are generally referred to as less-than-a-load (LTL) loads. With these loads, logistic companies often try to add multiple LTL loads together to make a full load for the transportation vehicle. Such LTL loads may require the transportation vehicle to access multiple origin locations, meaning the vehicle may pick up different LTL loads at different origin locations. Alternatively, in the case of the origin location being a warehouse that houses objects from many different suppliers and for many different customers, the vehicle may be able to pick up different LTL loads all at the same origin location.

The transportation request may also include additional information, for example, an origin location, a requested delivery time and/or date, a schedule for the transportation request, a customer associated with the transportation request, an applicable supplier, any requests associated with the transportation request, restrictions associated with the transportation object (e.g., a stacking height, loading type restrictions (e.g., fork lift loading, hand loading, etc.), restrictions against loading with other objects (e.g., cannot be loaded with other food items to maintain Kosher requirements, cannot be loaded with combustible materials, can only be loaded with other products of the same type, cannot be loaded with other loads, etc.), load size restrictions, etc.), load cover requirements (e.g., van or box, tarped, open, chained, etc.), a preferred transportation vehicle type, and/or the like.

From the transportation request, a system can generate a transportation order for the object(s) of the transportation request. The transportation order(s) can then be used to generate a shipment plan. The shipment plan identifies the details regarding how the objects will be transported from an origin location to a destination location. The transportation orders may include the details for the transportation of objects for a part of the shipment plan. For example, a transportation vehicle that will be transporting multiple object types may have transportation orders for each of the object types that are being transported. The combination of these transportation orders makes up the shipment plan. Transportation orders may be generated for different characteristics, for example, transportation orders may be based upon an object type, may be based upon destinations (e.g., an object would have a transportation order for the transport from location A to location B and another transportation order for the transport from location B to location C, etc.), may be based upon certain time frames (e.g., an object would have a transportation order that encompasses a first 10-hour time frame and another transportation order for a second 10-hour time frame, etc.), may be based upon the transporter or transportation vehicle of different portions, and/or the like.

From the transportation orders, the system can generate a shipment plan which is an aggregation of the transportation orders. In generating the transportation orders and/or shipment plan, the system validates the variables of the transportation. As discussed further herein, the variables can include a number of items or objects within the shipment, identifiers of objects (e.g., object names, object types, object stock keeping units (SKU), etc.), origin location, destination location, transportation vehicle, transportation vehicle type, transportation vehicle identifier (e.g., license plate number, federal identification number, transporter identification number, transportation company, etc.), transporter and/or transporter identifier, receiver identifier, time of departures, time of arrivals, number of drops within the shipment, and/or the like. Thus, the variables can be any information that may be included in a transportation request, transportation order, shipment plan, and/or master data within the shipment ordering system. This validation includes ensuring that the variables are correct in view of any transportation constraints, inventory constraints, location constraints (e.g., origin location constraints, destination location constraints, etc.), or any other information included in the master data. Thus, the system may compare the variables against any master data information. Accordingly, the transportation orders and, therefore, the shipment plan, are generated so as to meet or fulfill any information contained within the master data. This means that the transportation orders and shipment plan have been validated against the master data.

Additional information related to the transportation request, the generation of transportation orders, and the generation of shipment plans, can be found in commonly owned application having serial number 18/947,887, entitled “Transportation Optimization”, and filed on November 14, 2024, the contents of which are incorporated by reference herein as if they were fully set forth herein.

Once the shipment plan has been generated and approved, the master data exception system can track the transportation that occurs per the shipment plan. Execution of the shipment plan begins when a transportation vehicle is chosen and dispatched to pick up the objects and ends when the objects have been delivered. In other words, the execution of the shipment plan begins when any part of the shipment plan has been started and ends when all parts of the shipment plan have been completed.

The tracking of the transportation may be performed using sensors (e.g., global positioning system (GPS) sensors, proximity sensors, accelerometers, gyroscopes, movement sensors, speed sensors, etc.), devices having sensors, inputs provided by users or people involved in the transportation (e.g., transporters, loaders, unloaders, receivers, shippers, etc.), devices or components that can provide timestamps, and/or the like. The tracking occurs between the origin location and the destination and includes information that identifies events related to the objects and a time of occurrence of the events. Events may include a pick-up of the objects, a drop-off of the objects, any events occurring therebetween, and/or the like. The tracking of the transportation may include tracking any information that may be relatable to the shipment plan and/or master data. In other words, the tracking can include tracking any information related to inventory constraints, transportation constraints, location constraints, and/or any other information related to the master data. Some of this information may be directly trackable from inputs received from sensors, user input, devices, and/or the like, for example, user inputs may identify that a delivery was not made, sensors may identify how heavy a load is, devices may be used to scan barcodes to identify products, and/or the like.

The tracking of information may include correlating information to the master data in view of information that can be directly tracked. In other words, some information may be able to be tracked directly, for example, from sensors, user input, devices, and/or the like, but this specific information is not included in the master data. Rather, information may be included in the master data that can be inferred, computed, or identified from the directly tracked information. Accordingly, when tracking the object during execution of the shipment plan, the system may make correlations between directly received information and information that can be utilized by the system. For example, proximity sensors may detect when a transportation vehicle carrying the objects passes by or through a checkpoint (e.g., gateway arches, toll booths, weigh stations, other areas with the ability to detect the presence of the transportation vehicle, etc.). Using timestamps associated with the transportation vehicle passing more than one checkpoint and based upon a distance therebetween, the system can estimate an approximate or average speed of the transportation vehicle through that area.

At 202, the master data exception system determines if an exception was identified during the execution of the shipment plan. An exception identifies a change with respect to the shipment plan that occurred during execution of the shipment plan. In other words, an exception is some event that has occurred that does not match the shipment plan. Exceptions may include deliveries not made on time, pick ups not made on time, a different transportation vehicle being utilized, a different transporter being utilized, identification of a transporter changing, and/or the like. The exception may be any event that is different from the shipment plan. To identify the exception, the master data exception system may utilize one or more techniques, which may include, but are not limited to, receiving input from a user identifying the exception, performing computations that identify an exception, identifying discrepancies between tracked information and information of the shipment plan, and/or the like, or a combination thereof.

The master data exception system may identify an exception based upon receiving input from a person executing the shipment plan. From this input, the system may identify a discrepancy between the shipment plan (which is identified from the master data) and what actually happened during the execution of the shipment plan. In other words, this input may identify a discrepancy between the execution of the shipment plan and the master data via identification of a discrepancy between the execution of the shipment plan and the information of the shipment plan. Receipt of the input may be by a person involved in the execution of the shipment plan (e.g., transporter, shipper, unloader, loader, receiver, logistics company personnel, etc.) through a device that may be in operative communication with the master data exception system. Operative communication means that the device does not have to communicate directly with the master data exception system, but could, instead, communicate with a system that communicates with the master data exception system. For example, the device could communicate with a shipment tracking system which could then communicate with the master data exception system.

The person or user may provide input to a device, for example, via input to a display, via input to a graphical user interface, and/or the like. Alternatively, or additionally, the device may be used to collect information that is used as an input to the master data exception system. As an example, a device may be used to scan barcodes, load identifiers, and/or the like, a device may be used to weigh loads or collect information from devices or systems used to weigh loads, a device may be used to scan transportation vehicles as they pass by the device and collect the timestamps, and/or the like. The devices may be any type of device including, but not limited to, an information handling device (e.g., smart phone, laptop computer, personal computer, tablet, smart watch, smart appliance, etc.), handheld scanners, scales, and/or the like.

Performing computations and/or identifying discrepancies between tracked information and the information of the shipment plan can include comparing the tracking information to the information of the shipment plan, thereby allowing the system to determine if the transportation is occurring per the shipment plan. In other words, the system can perform the tracking in view of or with respect to the shipment plan. By comparing this information to the shipment plan, the master data exception system can identify if an exception has occurred during the execution of the shipment plan. For example, based upon the comparison, the system may identify a discrepancy between the expected value of the shipment plan (which is identified from the master data) and the actual value identified during execution of the shipment plan. In other words, based upon the comparison the system may identify a discrepancy between an expected value identified from the master data and an actual value identified during the execution of the shipment plan via identification of a discrepancy between the execution of the shipment plan and the information of the shipment plan.

The master data exception system may perform any steps needed to compare the tracked information to the shipment plan. In other words, the system takes steps to correlate the information that was received during the tracking to the information contained in the shipment plan, which may include manipulating the tracked information to match the information contained within the shipment plan. For example, if the shipment plan has identified how long the transportation trip should take and the tracked information identifies a pick up timestamp and a drop off timestamp, the system may take steps to determine the trip length from the timestamps. Obviously, this is a simple example, but the system can perform much more complicated correlations or calculations to manipulate the tracked information to match information contained within the shipment plan.

It should be noted that matching does not mean that the information is made to be exactly what is stated in the shipment plan. Rather, matching means that the tracked information is manipulated to have the same format as the information contained within the shipment plan. In other words, and using the timestamp example above, the tracked information in the form of timestamps is manipulated to match the trip length format of the shipment plan. To perform these manipulations, the systems may utilize any type of computation technique, algorithm, and/or the like, for example, simple mathematical computations using formulas, rules engines, databases, artificial intelligence models, and/or the like.

Since the shipment plan is created from the master data, when an exception occurs to the shipment plan, the master data exception system may attempt to identify the master data that was used to generate the information within the shipment plan that was the focus of the exception. It should be noted that while a single exception is discussed herein, during the execution of a shipment plan, multiple exceptions can occur. Thus, the system performs the same steps for all exceptions that were identified. Since the shipment plan is created from master data, the shipment plan information can be correlated to the master data. For example, if the shipment plan indicates that the load needs to be delivered between a certain time frame, the master data that resulted in this shipment plan information may be information related to a destination location’s open hours, a destination location’s loading dock hours, a destination location’s personnel working hours, and/or the like, or a combination thereof. Thus, a single piece of information on the shipment plan can be correlated to multiple pieces of master data.

However, the master data exception system knows what information was used to create the shipment plan since the master data exception system is either the system that created the shipment plan or is in communication with the system that creates the shipment plan. Alternatively, or additionally, within the master data exception system, for example, in the master data repository, it may be identified what shipment plan information is influenced by what master data. For example, the master data repository may identify that destination location open hours will influence a drop off time, a pick up time (in order to reach the destination during the open hours), and/or the like. Each piece of master data may influence a single piece of shipment information or may influence multiple pieces of shipment information. Regardless of how the master data exception system knows which master data is correlated to the shipment plan information, the master data exception system is able to correlate the exception to the master data. Thus, from the identification of the exception, the master data exception system is able to identify the master data (which may include more than one piece of master data) that is affected, or possibly affected, by the exception.

The master data exception system may also receive additional data that is able to more specifically identify the master data that is affected by the exception. For example, if a transporter arrives at a destination location to deliver a load and is unable to deliver the load, the transporter may be able to provide input that indicates why the load was unable to be delivered. As an example, the transporter may access a graphical user interface presented in an application on a smart phone and indicate that the load was unable to be delivered. Upon identifying that the load was undeliverable, the transporter may be presented with an input area that allows the transporter to identify why the load was undeliverable. For example, the user could be presented with a free-form input area, could be presented with a drop down menu having prepopulated potential reasons that the user can select, and/or the like. As an example, in the case of an undeliverable load, the prepopulated reasons may include “loading dock closed,” “receiving personnel on break,” “receiving personnel sick,” “loading dock unable to accommodate transportation vehicle,” “unloading equipment unavailable,” and/or the like. Each of these reasons may be correlated to a specific, or more specific, set of master data.

Additionally, some of the tracking information can be correlated to more specific master data. As an example, while tracked speed data may correlate to a shipment plan exception related to trip travel time exceeding expected trip travel time, that same tracked speed data can be correlated to master data related to a speed limit of a particular road or portion of the transportation route. Thus, the tracking information may also be utilized to more specifically identify the master data that may be affected by the exception. The system can use one or more artificial intelligence models to identify that an exception has occurred, identify the shipment plan information that is correlated to the exception, identify the master data that is correlated to the exception, and/or the like.

If, at 202, an exception was not identified during execution of the shipment plan, the system may take no action with respect to the master data at 204. Alternatively, if the exception cannot be correlated to the shipment plan or master data, the system may take no action with respect to the master data. Additionally, some exceptions may occur that have no bearing on the master data. In these cases, the master data exception system will not take any action with respect to the master data. For example, if the transporter gets a flat tire, while this does affect the shipment plan, it is not because the master data was incorrect or needs changed. When identifying the master data, the master data exception system is attempting to identify master data that may need to be changed or at least reviewed in view of the exception. Thus, if an exception occurs that should not affect the master data, the system may take no action with respect to the master data.

If, on the other hand, at 202, an exception was identified during execution of the shipment, the system may automatically update the master data upon receipt of a predetermined number of exceptions at 203. In other words, the master data exception system may automatically update, based upon receipt of a predetermined number of exceptions corresponding to the same master data, the master data corresponding to the exception. In making the automatic update, the system may utilize an artificial intelligence model to identify the master data that is affected by the exception, identify the predetermined number of exceptions that should be received to update the master data, and/or the like. The system may also make the automatic changes based upon input by a user indicating that a change should be made to the master data. In this case, the user may not indicate that a specific change should be made, but rather may identify that a particular exception should result in the master data being changed. For example, a user could identify that particular exceptions keep occurring and may then provide a trigger to the system to effectuate the modification in the master data.

As mentioned, the exception that was identified may be also identified as an exception that affects the master data. Automatically updating the master data includes making changes to the master data to reflect the reality that occurred during the execution of one or more shipment plans. In other words, the master data is updated to reflect the information captured within the exception. For example, if an exception indicates a change to the loading dock hours, the master data will be updated to change the loading dock hours to match what is identified in the exception. The number of shipment plans that have to be affected may vary based upon the predetermined number of exceptions that need to be received in order to update the master data that corresponds to the exception. Thus, when identifying exceptions, the master data exception system identifies the master data that is affected by an exception and keeps track of the number of exceptions that are related to this master data. Once the number of exceptions, or frequency of exception that are related to this master data, has been reached, then the system updates this master data to compensate for or reflect the exception.

The predetermined number of exceptions may vary across different pieces or types of master data and may also vary based upon the type of exception that has occurred. In other words, the predetermined number of exceptions may vary based upon the types of master data, the types of exceptions, and/or the like. The predetermined number of exceptions may be a specific number of exceptions, may be a frequency of exceptions, and/or the like. For example, an exception that is related to a full closure of a road for a specific length of time may only require a single occurrence to make the change to the master data. In this case, the change may be a temporary change that has an expiration corresponding to when the road is supposed to be reopened. Thus, updates to master data can be temporary. As another example, an exception that is related to being unable to deliver a load due to the loading dock being closed, may require more exceptions since the closure may be a single occurrence. Over time, the system may learn, using the artificial intelligence model, how many exceptions are required for different types or pieces of master data before the master data will be updated.

In addition to updating the master data, or potentially before updating the master data, the system may flag the master data that was update or that is to be updated. The master data exception system may then request a validation of the master data that was flagged. In other words, the system may request that a user validate that the master data should be changed or should remain changed. Upon receiving a positive validation (meaning a validation indicating that the master data should remain changed or should be changed), the system may finalize the change to the master data by removing the flag and changing the master data in the event that it has not been changed yet. Upon receiving a negative validation (meaning a validation indicating that the master data should not be changed), the system may remove the flag and then not make the change if it has not already been made or reverting the change in the event that it had been made.

The updated master data can then be utilized to make subsequent shipment plans that more accurately reflect reality. Thus, the shipment plans can become more accurate over time without requiring a user to have to track and manually make changes to the master data. This allows the transportation field to become more efficient, thereby resulting in fewer exception, fewer delays, and a more optimized transportation of objects.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated. Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
tracking, utilizing a master data exception system, transportation of at least one object during execution of a shipment plan, wherein the shipment plan is generated using master data and comprises at least one transportation order for the at least one object;
identifying, based upon the tracking, an exception during the execution of the shipment plan, wherein the exception identifies a change with respect to the shipment plan that occurred during execution of the shipment plan; and
automatically updating, based upon receipt of a predetermined number of exceptions corresponding to the same master data, the master data corresponding to the exception.

2. The method of claim 1, wherein the identifying of the exception comprises tracking a transportation vehicle during execution of the shipment plan and identifying a discrepancy between an expected value identified from the master data and an actual value identified during the execution of the shipment plan.

3. The method of claim 1, wherein the identifying of the exception comprises receiving input from a person executing the shipment plan, wherein the input identifies a discrepancy with the master data.

4. The method of claim 1, wherein the predetermined number of exceptions comprises a frequency of exceptions related to the same master data.

5. The method of claim 1, wherein the predetermined number of exceptions varies based upon a type of the master data.

6. The method of claim 1, comprising flagging the master data that was updated and requesting validation of the master data that was flagged.

7. The method of claim 6, finalizing the update to the master data based upon a validation of the master data that was flagged.

8. The method of claim 1, wherein the automatically updating comprises utilizing an artificial intelligence model to identify the predetermined number of exceptions.

9. The method of claim 1, wherein the tracking is responsive to generation and approval of the shipment plan.

10. The method of claim 1, wherein the master data is stored in a data repository accessible by the master data exception system and comprises data related to at least one of: inventory constraints, transportation constraints, and destination constraints.

11. A system, the system comprising:
a processor;
a memory device that stores instructions that, when executed by the processor, causes the system to:
track, utilizing a master data exception system, transportation of at least one object during execution of a shipment plan, wherein the shipment plan is generated using master data and comprises at least one transportation order for the at least one object;
identify, based upon the tracking, an exception during the execution of the shipment plan, wherein the exception identifies a change with respect to the shipment plan that occurred during execution of the shipment plan; and
automatically update, based upon receipt of a predetermined number of exceptions corresponding to the same master data, the master data corresponding to the exception.

12. The system of claim 11, wherein the identifying of the exception comprises tracking a transportation vehicle during execution of the shipment plan and identifying a discrepancy between an expected value identified from the master data and an actual value identified during the execution of the shipment plan.

13. The system of claim 11, wherein the identifying of the exception comprises receiving input from a person executing the shipment plan, wherein the input identifies a discrepancy with the master data.

14. The system of claim 11, wherein the predetermined number of exceptions comprises a frequency of exceptions related to the same master data.

15. The system of claim 11, wherein the predetermined number of exceptions varies based upon a type of the master data.

16. The system of claim 11, comprising flagging the master data that was updated and requesting validation of the master data that was flagged.

17. The system of claim 11, wherein the automatically updating comprises utilizing an artificial intelligence model to identify the predetermined number of exceptions.

18. The system of claim 11, wherein the tracking is responsive to generation and approval of the shipment plan.

19. The system of claim 11, wherein the master data is stored in a data repository accessible by the master data exception system and comprises data related to at least one of: inventory constraints, transportation constraints, and destination constraints.

20. A product, the product comprising:
a computer-readable storage device that stores executable code that, when executed by a processor, causes the product to:
track, utilizing a master data exception system, transportation of at least one object during execution of a shipment plan, wherein the shipment plan is generated using master data and comprises at least one transportation order for the at least one object;
identify, based upon the tracking, an exception during the execution of the shipment plan, wherein the exception identifies a change with respect to the shipment plan that occurred during execution of the shipment plan; and
automatically update, based upon receipt of a predetermined number of exceptions corresponding to the same master data, the master data corresponding to the exception.
